(19) United States
(12) Patent Application Publication
(10) Pub. No.: US 2015/0019807 A1
(43) Pub. Date: Jan. 15, 2015

(54) LINEARIZED DYNAMIC STORAGE POOL

(71) Applicant: Silicon Graphics International Corp., Milpitas, CA (US)

(72) Inventors: Kirill Malkin, Morris Plains, NJ (US); Yann Livis, Bedminster, NJ (US)

(21) Appl. No.: 14/328,423

(22) Filed: Jul. 10, 2014

Related U.S. Application Data
(60) Provisional application No. 61/845,162, filed on Jul. 11, 2013.

(51) Int. Cl. G06F 3/06

(52) U.S. Cl. CPC G06F 3/0644; G06F 3/0689; G06F 3/0619; G06F 3/0665
USPC 711/114

(57) ABSTRACT

The present technology provides a two step process for providing a linearized dynamic storage pool. First, physical storage devices are abstracted. The physical storage devices used for the pool are divided into extents, grouped by storage class, and stripes are created from data chunks of similar classified devices. A virtual volume is then provisioned from and the virtual volume is divided into virtual stripes. A volume map is created to map the virtual stripes with data to the physical stripes, linearly mapping the virtual layout to the physical capacity to maintain optimal performance.

### CROSS-REFERENCE TO RELATED APPLICATIONS

This application claims the priority benefit of U.S. Provisional Application Ser. No. 61/845,162, titled “Linearized Dynamic Storage Pool,” filed Jul. 11, 2013, the disclosure of which is incorporated herein by reference.

### BACKGROUND

Traditional computer storage systems designed to store information in the form of fixed-size blocks of data or variable-length named data files organized in a named folder hierarchy typically deploy multiple physical storage devices (disk drives) to meet capacity and performance targets required by application(s) that access the data on the storage system. The more disk drives are deployed, the higher is the probability of a spontaneous storage system failure resulting from a failure of an individual component. The failure of a storage system typically leads to a failure of the application, resulting in a costly disruption of business.

In effort to reduce the chances of a storage system failure, storage system vendors add redundancy to the data stored by the storage system so that a failure of one or more physical storage devices could be sustained without impact to the application. This is accomplished by assembling disk drives in so-called RAID groups. RAID stands for a “Redundant Array of Independent Disks”. Within a RAID group, each disk is assigned a certain role (data or parity), and the data is stored in stripes of a fixed size. In case of a failure of one or more disk drives, the redundant parity information is used to rebuild the missing data on the fly. The rebuilt data is also stored on a spare drive, if available, and once the rebuild is complete, the failed drive can be replaced with a new spare. The disk drive role (data or parity) can change depending on the “RAID Level” and the relative location of data (stripe number), based on a certain predefined algorithm.

RAID groups have severe limitations. For example, drives are dedicated to a certain position inside RAID group and their number is fixed, all drives must be the same size (the extra capacity is lost), RAID groups yield a fixed, fully provisioned capacity. Custom capacity, on-demand (“thin”) provisioning and data protection functions such as snapshots, data reduction or replication require additional virtualization layers implemented on top of RAID group, it is not possible to introduce a new RAID level or new stripe size on a set of drives already participating in a RAID group, altering the RAID level, the number of drives in the group or the stripe size directly in place is possible, but is a very lengthy and dangerous operation requiring a full rewrite (“restriping”) of the RAID group, and growing usable capacity of the RAID set is possible, but effectively involves adding a new RAID group with the same number of drives as the original. Further, spare drives need to be installed ahead of time and are aging along with the rest of the group, writing parity and data can't be precisely synchronized; therefore extra measures are necessary to protect the integrity of the data stored in a RAID group across sudden power losses (“write hole” problem), and RAID group performance characteristics are defined by the number of drives in the group and the stripe size. Additional data distribution mechanisms are required to realize performance of multiple RAID groups.

What is needed is a more efficient mechanism for providing a storage pool.

### BRIEF DESCRIPTION OF FIGURES

FIG. 1 is a block diagram of layout components.

FIG. 2 is a block diagram of a layout example.

FIG. 3 is a method for constructing virtual storage volumes.

FIG. 4 is a block diagram of snapshots and clones.

FIG. 5 is a method for linearizing an allocation of stripes.

FIG. 6 is a block diagram of strides and stretches.

FIG. 7 is a block diagram of direct and epsilon stripes.

FIG. 8 is a block diagram of sister stretches.

FIG. 9 is a block diagram of a computing system.

### SUMMARY

A two step process is implemented to provide a linearized dynamic storage pool. First, physical storage pools are abstracted. The physical storage devices used for the pool are divided into extents, grouped by storage class, and stripes are created from data chunks of similar classified devices. A virtual volume may be provisioned and the virtual volume is divided into virtual stripes. A volume map is created to map the virtual stripes with data to the physical stripes, mapping the virtual layout to the physical capacity.

A method for constructing virtual storage volumes may begin with dividing each of a plurality of physical storage devices into a plurality of extents. Each extent may be divided into a plurality of chunks. A plurality of sheets may be assembled from the extents. A plurality of stripes may be assembled from the chunks. The sheets may be linearly concatenated into layouts using a linear vector called sheet map. One or more stripes may be allocated to a virtual volume.

A computer system may include memory, one or more processors and an application. The may be stored in memory and executable by the one or more processors to divide each of a plurality of physical storage devices into a plurality of extents, divide each extent into a plurality of chunks, assemble a plurality of sheets from the extents, assemble a plurality of stripes from the chunks, linearly concatenate the sheets into layouts using a linear vector called sheet map, and allocate one or more stripes to a virtual volume.

### DETAILED DESCRIPTION

The present technology provides a two step process for providing a linearized dynamic storage pool. First, physical storage devices are abstracted. The physical storage devices used for the pool are divided into extents, grouped by storage class, and stripes are created from data chunks of similar classified devices. A virtual volume is then provisioned from and the virtual volume is divided into virtual stripes. A volume map is created to map the virtual stripes with data to the physical stripes, mapping the virtual volume to the physical capacity.

The present technology stores information in form of fixed-size blocks of data and provides more flexibility with less hardware than traditional architectures based on RAID groups. The present architecture is designed to incorporate rotating magnetic direct-access storage media, also known as “hard disk drives” as well as solid-state storage media, also known as “flash” or “NAND” storage.

A block storage resource is a random-access storage resource that has data organized in equal-sized blocks, typically 512 bytes each. Each block can be written or read in its entirety, but one can't read or update less than the entire block. The blocks may be numbered from 0 to the maximum number of blocks of the resource. Blocks are referenced by their numbers, and the access time for any block number is fairly similar across the entire resource. Blocks can also be grouped into equal size “chunks” of blocks. Hard disks, as well as flash SSD and USB sticks, are examples of block storage resources.

Block storage resources can be physical or virtual. A physical storage resource is a physical device, such as a hard disk or a solid state drive, that has a fixed number of blocks that is defined during manufacturing or low-level formatting process, usually at the factory. A virtual block storage resource is a simulated device that re-maps its block numbers into the block numbers of a portion of one or more physical block storage resources. As just two examples, a virtual block storage resource with 2,000 blocks can be mapped to: (1) a single physical block storage resource with 10,000 blocks, starting at block 1,000 and ending at block 2,999; or (2) two physical block storage resources, one with 1,000 blocks and another with 5,000 blocks, starting at block 0 and ending at block 999 of the first resource, then starting at block 3,000 and ending at block 3,999 of the second resource. The examples herein assume the use of virtual block storage resources, also known as “volumes”. However, it will be understood that physical block storage resources could instead be used.

A software-defined storage virtualization stack may provide dynamic allocation and redundancy. The software-defined storage virtualization stack may be considered a “storage processor” that connects to raw physical storage devices on one side and provides virtual block storage resources (hereinafter volumes) having required capacity, redundancy and storage class characteristics on the other. The storage processor acts as the “link” between the physical disks and the applications requiring reliable, efficient and expandable virtual storage volumes.

The present technology may be based on a two-stage linear virtualization principle. The first stage is a low-granularity, non-redundant equalization that breaks down all storage devices into large extents (256 MB to 4 GB, typically 1 GB). The extents are further broken down into small chunks (16 KB to 512 KB). The size of the chunk remains constant within an extent. One of the extents of each storage device at a predefined location, for example the first extent, is reserved for label and metadata. The examples of label information include but are not limited to: the unique identifier of the storage device and, time stamp of label creation, time stamp of label modification, event sequence number and label checksum. The examples of metadata content include but are not limited to: the unique device identifier of the storage pool, device sector size in bytes, extent size in bytes, extent map, layout table of content and volume table of content. Each physical storage device is also associated with a “storage class” according to its performance characteristics. This first stage can be thought of as physical device abstraction.

Disk striping is the process of dividing a body of data into blocks and spreading the data blocks across several chunks of several block storage devices. A stripe is a collection of a fixed number of chunks of identical size all residing on different physical storage devices. The logical location of each chunk within an extent may not be constant across the extents, and no two chunks within a stripe reside on the same physical storage device.

Chunks within a stripe are declared as data (payload or redundancy) or spare. A stripe can be all data or a combination of data and spare, but it could not be all spare. The parity calculation or mirroring algorithms can be applied to the chunks within a stripe in a variety of ways, creating stripes with single parity (XOR), dual parity (e.g. PQ, EVENODD), n-way mirror, erasure coded (i.e. m+n where n is the number of data chunks and n is the number of parity chunks) and even non-erasure-coded. The designation of chunks within a stripe could change (e.g. rotate) across the extent(s) based on a predefined algorithm. If the data stored in stripes include redundancy, then when a physical storage device (disk drive) fails partially or completely, the data stored on it could be recovered using redundancy methods.

The redundancy scheme, number of chunks in a stripe and chunk size, may be fixed for a particular set of extents. Another set of extents could use completely different parameters. This construction has two important consequences: there could be multiple data layout and redundancy schemes coexisting on the same set of physical drives, and the same data layout and redundancy scheme could be repeated across unlimited number of physical drives.

Each layout produces a virtually unlimited linear source of optionally redundant stripes mapped to physical storage devices. When the current extent set (or “sheet” of stripes) is exhausted, the next sheet is allocated. The mapping between the stripe number and physical storage device extents is stored in a linear vector structure called a “sheet map”. Therefore, converting layout stripe number to a physical device number and logical block address (LBA), involves only a direct table lookup and a simple arithmetical operation.

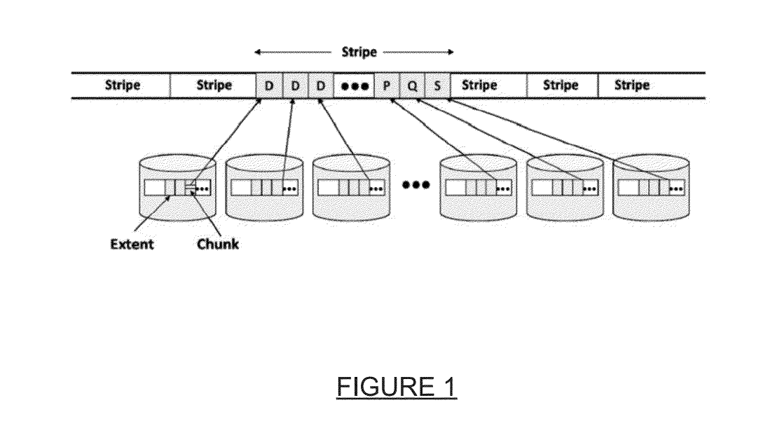

FIG. 1 is a block diagram of layout components. In FIG. 1, “D” stands for data chunks, “P” stands for the first parity chunk, “Q” stands for the second parity chunk and “S” stands for the spare chunk.

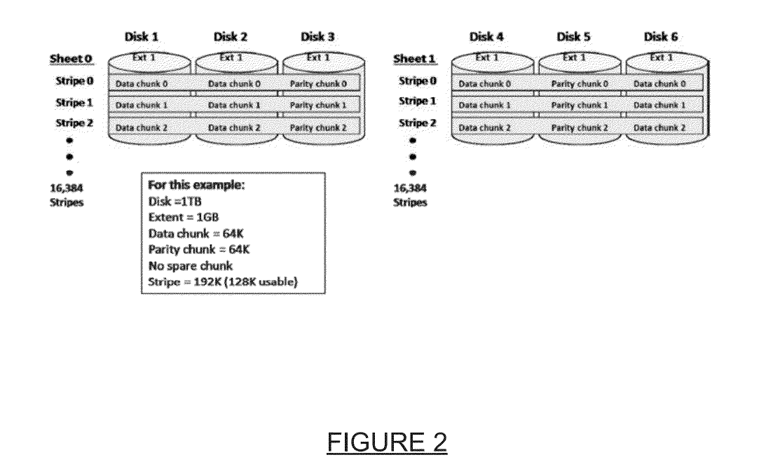

FIG. 2 is block diagram of a layout example. The layout example of FIG. 2 shows an example of a layout with two 64 kB data chunks and one 64 kB parity chunk residing on 6 different physical block storage devices 1 TB each divided into 1 GB extents. Each stripe carries 192 kB of data, with 128 kB of usable data and 64 kB of redundancy data. Note that although the storage devices are referred to as “Disk,” other types of storage devices could be used.

Physical storage devices can be dynamically added to the storage pool and their extents considered for allocating new sheets for all layouts. Any quantity of new devices can be added at any time, greatly simplifying the extension of pool capacity.

The second stage of storage virtualization maps the layout stripes to virtual volumes. The volumes are associated with a certain stripe layout and are logically broken into “virtual” stripes that match the data payload size (“cooked size”) of the layout stripes. In other words, the volume map only refers to the data payload chunks of the layout stripe, and does not store any information about the redundancy chunks. Each virtual volume stripe may or may not be mapped to a layout stripe within a sheet allocated to the layout.

The mapping between volume stripes and virtual stripe source is stored in a linear vector structure called a “volume map” created on a per-volume basis. Converting a virtual volume LBA to virtual stripe number and then to the physical layout stripe number involves only a simple arithmetical operation and a direct table lookup.

A virtual volume stripe only needs to be mapped when it is actually written. As such, when the virtual volume is initially allocated, no stripes are mapped. The virtual volume does not use any physical capacity unless allocated. As the volume receives write requests, the stripes are allocated and then written and finally mapped. This delivers storage provisioning on demand.

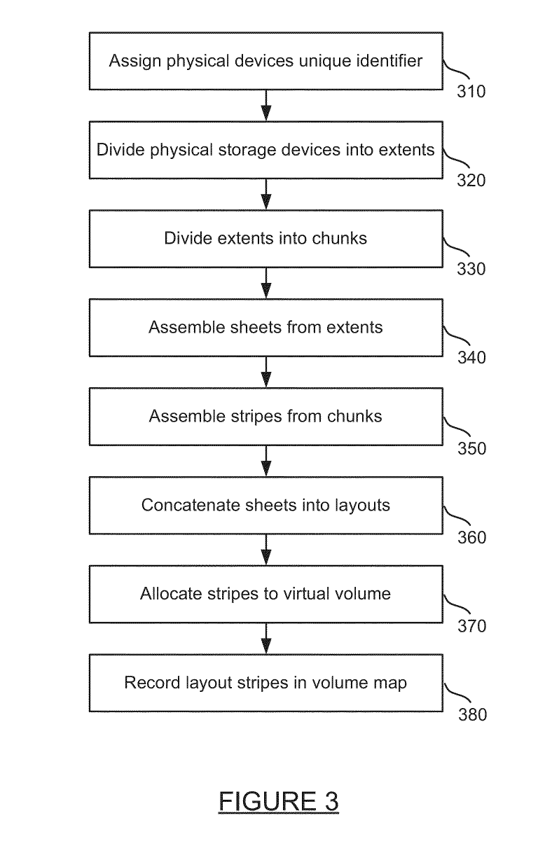

FIG. 3 is a method for constructing virtual storage volumes. The method of FIG. 3 begins with assigning each physical storage device a unique identifier at step 310. Each physical storage device may be divided into extents at step 320. The extents may be relatively large, for example, about one gigabyte, and may be equal in size. Each extent may be divided into chunks at step 330. The chunks may be relatively small, for example up to one megabyte, and may be equal in size.

A plurality of sheets may be assembled from the extents at step 340. The sheets may be assembled according to a layout, and each sheet may include a plurality of extents. Each of the plurality of extents may be associated with a different physical storage device of the plurality of physical storage devices.

A plurality of stripes may be assembled from the chunks at step 350. The stripes may be assembled according to the layout, and each stripe may include a plurality of chunks. Each of the plurality of chunks may be associated with a different extent of the plurality of equal-sized extents on a different physical storage device of the plurality of physical storage devices.

Sheets may be linearly concatenated into layouts at step 360. The linear vector, or “sheet map”, may be used to linearly concatenate the sheets into layouts. One or more stripes may be allocated to a virtual volume at step 370. The stripes may be allocated on demand by assigning an available layout stripe at the time of write. The assigned layout strip numbers are then recorded in a linear vector, or “volume map”, at step 380.

The present technology uses virtualization algorithms to direct writes to unreferenced (but pre-allocated) stripes, effectively solving the “write hole” problem. The “write hole” effect can happen if a power failure occurs during the write. It happens in all redundancy schemes, including but not limited to single parity, mirroring, etc. In this case, it is impossible to determine which of data chunks or parity chunks have been written to the disks and which have not. As a result, the redundancy data does not match to the rest of the data in the stripe. Also, one can't determine with confidence which data is incorrect—parity chunk(s) or one or more of the data blocks.

In the present system, the entire original stripe is read, modified and written into a new location, thus leaving the original stripe unchanged. When all chunks of the new stripe are guaranteed to be written out, then the mapping of the stripe within the volume (i.e. the volume map entry) is updated to point to the new stripe and the old stripe is de-allocated. This design significantly reduces the chances of data corruption caused by partial or incomplete writes.

The transactional design for writes facilitates a broad variety of storage virtualization functions, such as writeable snapshots, replication, and so on. Duplicating a volume-to-layout map effectively creates a snapshot of a virtual volume. When the origin volume is written, its map will redirect to stripes with new data while the other map will continue to point to stripes with the old data, facilitating the snapshot.

If a snapshot is present, the stripes with the old data cannot be de-allocated and made available as preallocated stripes again until the snapshot is deleted. This requires counting references (“claims”) to each stripe. For example, 16-bit counters permit up to 64K snapshots. The reference counters are stored in a vector structure called a “claim vector” allocated on a per-layout basis. Claim vector is a metadata structure that normally resides in memory (part or whole), and may be copied to a permanent storage inside or outside the dynamic storage pool so that it could be recovered after power down or failover event. Each counter has two special values that mean “not allocated” (e.g. 0) and “pre-allocated” (e.g. −1). All other values represent the cumulative number of references from all volume maps to the corresponding stripe. When a stripe is first mapped, its counter receives the value of 1.

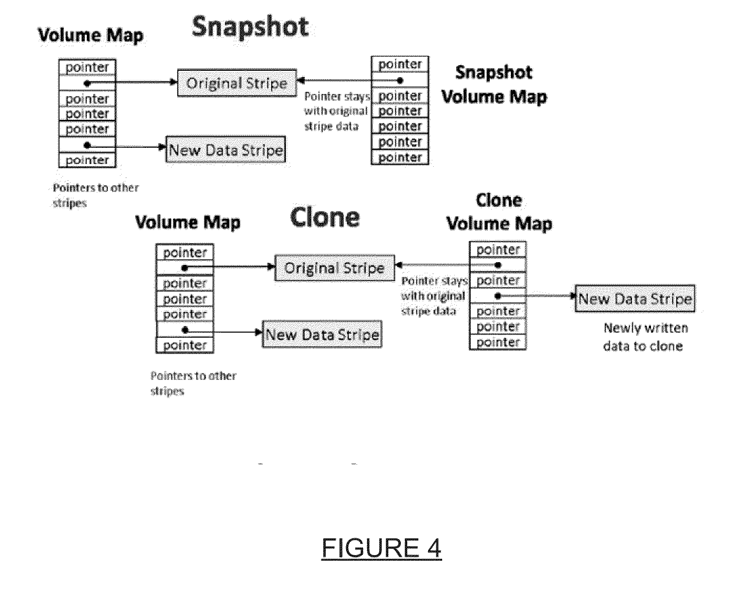

FIG. 4 is a block diagram of snapshots and clones. When a snapshot is created (i.e. the volume map is duplicated), it is necessary to increment the counters on all mapped stripes. This can be done asynchronously as long as stripe de-allocation is suspended (to prevent de-allocation as a result of writing to origin volume and releasing the stripe as part of the RMW operation). When a volume or snapshot is deleted, the counters on all mapped stripes are decremented. If a counter drops to zero, the stripe can be either sent to a pre-allocated pool (for subsequent mapping to virtual volume stripes) or de-allocated completely.

Many physical storage devices, especially those deploying rotating hard disk media, but also certain types of solid state devices, perform significantly better if the access to data (read, write or both) occurs in a sequential manner as it relates to device LBA (logical block address). This is either due to mechanical limitations or because of write amplification effects.

Most existing applications, particularly file systems and databases, are well aware of this fact and attempt to reorder and merge random I/O requests to present a more sequential workload to the storage device. Such techniques include, for example, a temporary delay of I/O processing (“queue plugging”), and applying “elevator” algorithms for a sequential ordering of accumulated I/O requests. In this way, file systems tend to allocate files contiguously to increase chances of sequential access.

In a virtualized storage system, the application is presented with virtual volumes, or “LUNs”, as if they were regular physical storage devices. A logical unit number, or LUN, is a number used to identify a logical unit, which is a device (e.g. block storage device) addressed by the SCSI protocol or protocols which encapsulate SCSI, such as Fibre Channel or iSCSI. Though not technically correct, the term “LUN” is often also used to refer to the logical block storage device itself. The applications will generally assume that these devices have the same properties as the physical storage devices, and will attempt to optimize the performance by delivering a sequential access pattern.

However, the abstraction and virtualization of physical storage devices inevitably leads to a “spaghetti mapping”, where sequentially occurring virtual stripes of the virtual volume do not always translate into sequential physical chunks of the physical storage devices. Hence, sequential I/O pattern of the virtual volume may translate into a random pattern by the time it reaches physical device. This negates the effects of application optimization and generally leads to a poor performance.

The present technology implements a proactive virtual capacity linearization method. It is based on pre-allocating contiguous ranges (“stretches”) of physical stripes in such a manner that their chunks also belong to contiguous ranges (“strides”) of the physical storage devices. The stretches of physical stripes are then mapped linearly to the stretches of virtual volume stripes as they are first written to. Subsequent writes to virtual stripes falling in the same virtual stretch range will continue to be linearly mapped to the same physical stride range. As a result, when a sequential I/O access occurs within the boundaries of a stretch, it is translated to a sequential access within a stride of a physical device. Only when the stretch boundary is crossed is it necessary to perform a random seek.

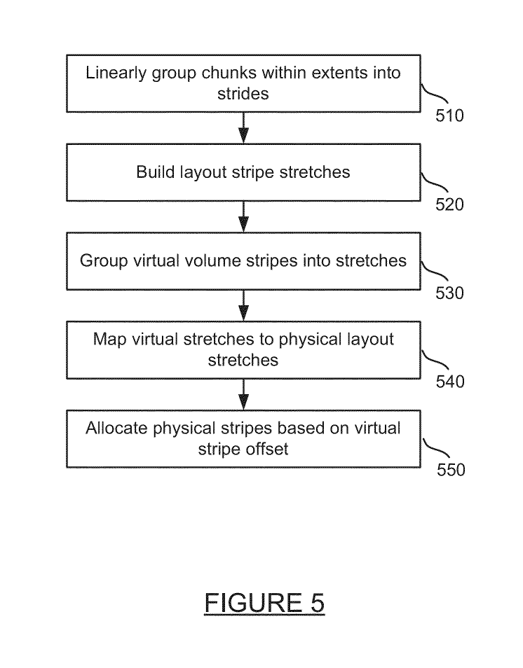

FIG. 5 is a method for linearizing an allocation of stripes. Chunks within extents are linearly grouped into strides at step 510. The chunks are grouped into fixed size strides, for example into eight megabyte strides. Layout stripe stretches are built at step 520. The layout stripe stretches are built from chunks that belong to the same stride. Virtual volume stripes are grouped into stretches at step 530. The grouped stretches are of the same size as layout stretches.

Virtual stretches are mapped to physical layout stretches at step 540. The mapping may be done on allocation of the first virtual stripe within a given stretch. Physical stripes are allocated based on virtual stripe offsets at step 550. The physical stripes may be allocated at the same offset as virtual stripes within their respective stretches provided that the physical stripe is available.

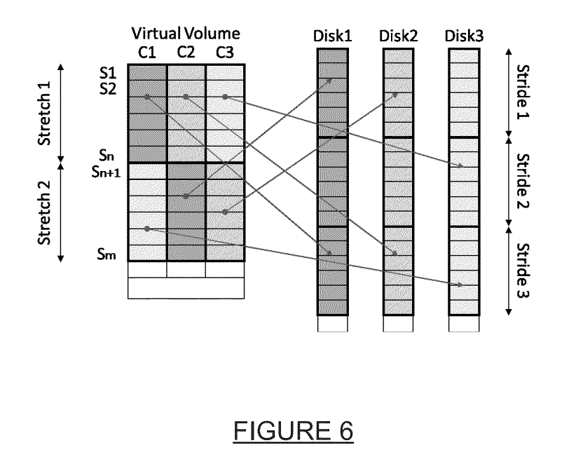

FIG. 6 is a block diagram of strides and stretches. “S” stands for a stripe, “C” stands for a chunk, and “Disk” stands for a storage device. If the stretch size is a magnitude larger than a typical I/O, then the performance loss from the spaghetti mapping would be under 10%, which is acceptable in most cases. The typical I/O rarely exceeds 1 MB, and there are typically more than 4 data chunks in a stripe. Based on these assumptions, the R-Pool stride size is set to 8MB, which results in less than 3% of performance loss during the full linear scan of a virtual volume. The performance numbers were obtained experimentally, by measuring performance impact on typical workloads.

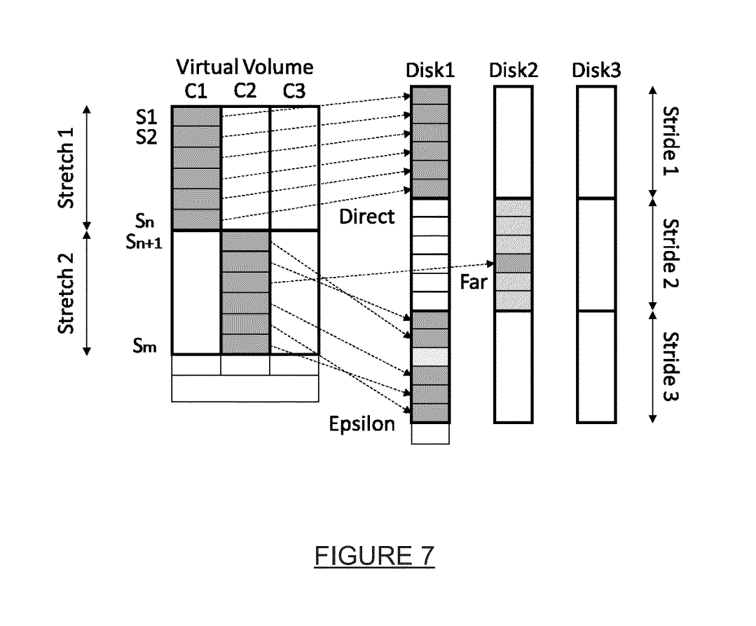

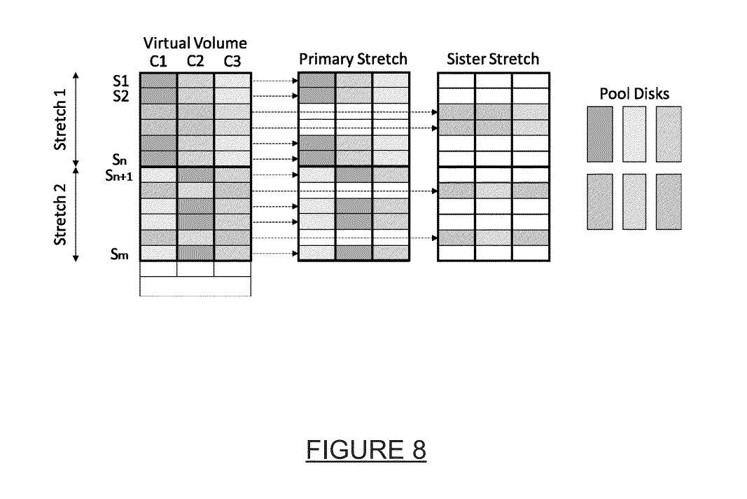

Due to the transactional nature of writes and the dynamic, on-demand allocation used in the R-Pool architecture, the directly corresponding physical stripe within a stretch may be already occupied with previously written data. Should this occur, there are three options for new stripe allocation. First, the system may attempt to allocate a nearby stripe within a range of no more than 2 stripes (“epsilon-area”). FIG. 7 is a block diagram of direct and epsilon stripes. This will cause a minor stripe address “flip” that could be absorbed by the physical storage device cache without a significant performance impact, and therefore is considered a “good” mapping. [00521 Second, the system may allocate a new “sister” stretch and look for a directly corresponding stripe there. FIG. 8 is a block diagram of sister stretches. This new stretch must be allocated on physical storage devices different from the ones mapped by the current stretch, so that they can be positioned independently. As the stripes are rewritten, they will migrate back and forth between the two stretch banks as shown below. Such mapping is also considered acceptable for purposes of the present invention since it will not significantly impact performance, i.e. a performance loss of less than a tenth. A performance impact within 10% is not considered significant. The primary stretch may be mapped to one set of devices, and a sister stretch may be mapped to another set.

Third, the present system may allocate any available stripe in layout, i.e. a “far” stripe. This will break linearization for this particular stripe. Such stripe mapping is considered “poor” because it will negatively impact performance.

When direct and epsilon stripe mappings are not available, the sister stretches will be frequently allocated. The eager allocation of sister stretches may lead to higher consumption of pre-allocated stretches. While it doesn't directly translate into more physical space allocation, it will lead to higher allocation of layout sheets. To minimize such effects, the pairs of sister stretches are dual-populated, i.e. the first physical stretch in a sister pair acts as the primary virtual stretch for one location, and the second physical stretch in the sister pair acts as the primary virtual stretch for another location. This allocation strategy results in a highly efficient population of physical stretches without significant performance impact.

If there are multiple virtual map references to the same physical stripe, as could be in the case of snapshots, then both stripes in the sister stretch will be used. This will also lead to allocating more physical layout stretches.

As the layout is further populated, the least desirable third allocation option (i.e. far stripe) may inevitably become more frequent, effectively de-linearizing the layout and impacting performance. As space is released (e.g. snapshots or volumes are deleted), and the writes to the volumes continue, it may be possible to reallocate stripes once again in a linear fashion. To assist this process, an allocation method may be used for far stripes. The allocation method begins with creating separate buckets of “good” stretches with predominantly direct or epsilon stripe mappings and “poor” stretches, with predominantly far stripe mappings. When new stripe needs to be allocated and direct or epsilon allocations are not available, then allocate new far stripes from the bucket of “poor” stretches. Next, the system will attempt to maintain direct or epsilon mappings within a stretch even for far stripes that don't belong to this stretch. For example, if only two stripes are available in a given stretch and most other stripes are mapped to other stretch(es) of the virtual volume, then try to allocate the stripe that is closer to a would-be direct or epsilon mapping.

The above far stripe allocation method results in self-linearization of the layout over time as more space becomes available. The proactive linearization of the layouts in the present system eliminates the need for costly defragmentation of the pool, as is typically deployed by many other storage solutions to maintain acceptable levels of performance.

Some applications tend to store multiple copies of identical data sets (e.g. files, VM images, etc.) There are known methods for identifying identical data instances, either a priori (preventing duplication of data, such as SCSI Extended Copy) or post-factum (locating duplicate data, such as comparing “data fingerprint” hashes). Virtualization by the present system enables simple integration of these methods to reduce the number of physically stored data instances.

When the system detects that a virtual volume stripe is identical to an existing virtual volume stripe, it sets the virtual volume map to point to the identical existing virtual volume stripe. This effectively reduces the amount of physical storage space required to store the data. The utilization of physical layout stripes is tracked by reference counters stored in the claim vector. The counters need to be incremented for each new mapping and decremented when the mapping is removed. This method of data reduction requires that current or future identical data spans are aligned to strip boundaries.

When a copy of data is subsequently overwritten, the virtual stripe mapping is changed to point to a new physical layout stripe. That stripe in turn is then shared with other virtual stripes of the same or other virtual volumes.

Modern operating systems and applications can inform a storage system that a certain portion of volume LBA space is no longer in use and the data on it is irrelevant. Alternatively, the application may want to initialize a certain portion of the volume LBA space to store all zeroes. This information is usually delivered via SCSI “Unmap” command or “Write Same” command.

As the present architecture is based on linear mapping of virtual volume stripes, it supports both the “unmapped” stripe state (when a volume is first created, all stripes are unmapped) and a special pointer to an “all zero” stripe that is never stored and is delivered algorithmically (i.e. zeroed out as opposed to copied). Unmapped and zero stripes help increase storage system efficiency and improve layout linearization.

In many cases, the data stored by applications can be significantly reduced in size by applying data compression algorithms. The present architecture allows the storage of multiple compressed virtual stripes within a single physical layout stripe.

Compressed stripes are enabled by a flag (for example, a single bit) in the claim vector entry indicating the presence of an internal stripe format. In some instances, the stripe does not simply contain the payload data of the volume in a compressed form, but also accommodates metadata describing how the compressed data that is stored within the stripe. It becomes possible because the compressed data consumes less space than the entire stripe and that extra space can be used for the metadata.

The internal format starts with a header descriptor block (512 bytes) that contains the number of blocks with the compressed data that follows; the checksum information that is used to validate the integrity of the stored data; the unique identifier of the virtual volume; and the stripe number of the volume. The header descriptor block is followed by a number of blocks with compressed data as described in the metadata. After that, one of two descriptor blocks could follow. Another header descriptor block may indicate that more compressed data (for another virtual volume stripe) is present. A footer descriptor block may indicate there is no more data stored in this layout stripe.

Since only a portion of a stripe is utilized for a compressed stripe, the present algorithms attempt to coalesce multiple compressed virtual stripes within a single physical one and that way write out multiple virtual volume stripes into a single layout stripe at once.

Alternatively, compressed virtual stripes can be added to the existing layout stripe at a later time. In this case, the footer descriptor block is overwritten with a new header descriptor block when the stripe is written out.

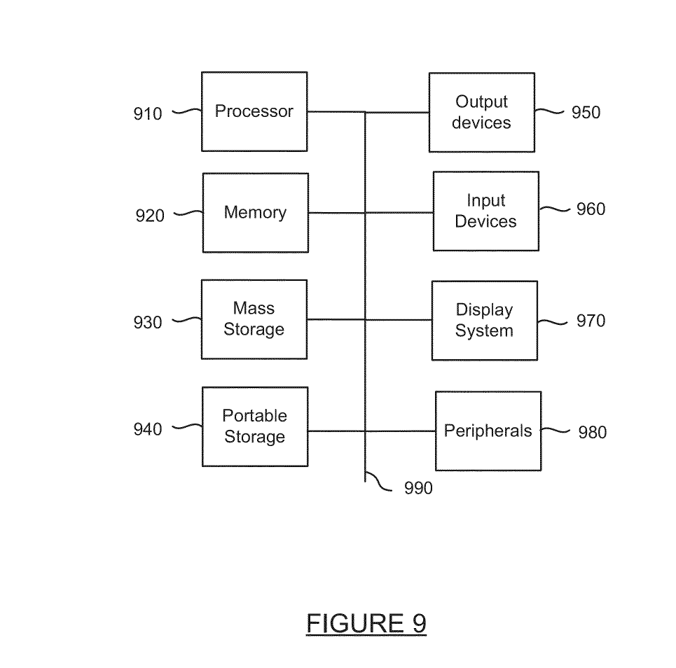

FIG. 9 is a block diagram of a computing environment for use in the present technology. System 900 of FIG. 9 may be implemented in the contexts of the likes of a server or other computing device that may provide one or more SDDs, HDDs, or other storage components suitable for implementing the present technology. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable non-volatile storage medium, memory card, USB memory stick, or on-board memory to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, cursor direction keys, or touch panel. Additionally, the system 900 as shown in FIG. 9 includes output devices 950. Examples of suitable output devices include speakers, network interfaces, and monitors.

Display system 970 may include a liquid crystal display (LCD) or other suitable display device. Display system 970 receives textual and graphical information, and processes the information for output to the display device.

Peripherals 980 may include any type of computer support device to add additional functionality to the computer system. For example, peripheral device(s) 940 may include a modem or a router, network interface, or USB interface.

In some embodiments, the system of FIG. 9 may implement a mobile device, such as for example a smart phone. In this case, the system may include additional components, such as for example one or more antennas, radios, and other wireless communication equipment, microphones, and other components.

A system antenna may include one or more antennas for communicating wirelessly with another device. Antenna may be used, for example, to communicate wirelessly via Wi-Fi, Bluetooth, with a cellular network, or with other wireless protocols and systems. The one or more antennas may be controlled by a processor, which may include a controller, to transmit and receive wireless signals. For example, a processor may execute programs stored in memory to control antenna to transmit a wireless signal to a cellular network and receive a wireless signal from a cellular network.

Microphone may include one or more microphone devices which transmit captured acoustic signals to processor and memory. The acoustic signals may be processed to transmit over a network via antenna.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for constructing virtual storage volumes, comprising
dividing each of a plurality of physical storage devices into a plurality of extents;
dividing each extent into a plurality of chunks;
assembling a plurality of sheets from the extents;
assembling a plurality of stripes from the chunks;
linearly concatenating the sheets into layouts using a linear vector called sheet map; and
allocating one or more stripes to a virtual volume.

2. The method of claim 1, wherein the plurality of sheets are assembled based on a layout.

3. The method of claim 1, wherein the plurality of stripes assembled based on a layout.

4. The method of claim 1, wherein each sheet comprising a plurality of extents, each of the plurality of extents associated with a different physical storage device of the plurality of physical storage devices.

5. The method of claim 1, wherein each stripe comprising a plurality of chunks, each of the plurality of chunks associated with a different extent of the plurality of equal-sized extents on a different physical storage device of the plurality of physical storage devices.

6. The method of claim 1, wherein the stripes are allocated on demand by assigning an available layout stripe.

7. The method of claim 1, further comprising recording the assigned layout stripe numbers in a linear vector called volume map.

8. The method of claim 1, further comprising assigning each of a plurality of physical storage devices a unique identifier.

9. The method of claim 1, where chunks including stripes of the same layout are received from extents of physical storage devices belonging to same storage class as defined by their performance characteristics.

10. The method of claim 1, where chunks include stripes of same layout utilize a same redundancy scheme.

11. The method of claim 1, where one or more of the chunks of a given stripe according to the layout act as pre-allocated spare capacity, wherein missing data is stored upon redundancy-based rebuild when the data residing on one or more of the chunks is no longer available due to corresponding physical storage device(s) failure.

12. The method of claim 1, where allocated and mapped stripes are only overwritten if the volume map points to a different stripe.

13. The method of claim 12, wherein for any new write, a new physical stripe is allocated and old data from a previous stripe that is not being overwritten is copied over to the new stripe.

14. The method of claim 1, where an additional linear structure tracks a number of volume map references for each stripe in a layout.

15. The method of claim 1, the method further comprising:
linearly grouping the chunks within extents into strides of a fixed size;
building layout stripe stretches out of chunks that belong to the same strides;
grouping virtual volume stripes into stretches of a same size as layout stretches;
dynamically mapping virtual stretches to physical layout stretches on allocation of the first virtual stripe within a given stretch; and
allocating physical stripes at a same offset as virtual stripes within their respective stretches.

16. The method of claim 15, wherein an alternate layout stripe within the same layout is allocated if the physical stripe is not available by allocating a nearby stripe within two stripes of directly mapped stripe, checking the presence of a “sister” stretch if a nearby stripe is not available, allocating either a direct or an epsilon-area stripe from a sister stretch if the sister stretch exists, allocating a sister stretch if the sister stretch exists, and allocating a “far” stripe in a layout stretch containing far stripes when no more layout stretches are available.

17. The method of claim 14, where duplicate data is eliminated by having destination virtual stripes point to the source stripe and increase a claim vector count for the source stripe.

18. The method of claim 14, where the physical storage capacity utilization can be reduced by monitoring for multiple instances of identical layout stripes, remapping all volume map references to a single layout stripe that is one of the identical layout stripes, increasing the claim vector reference count of the single stripe by the number of identical layout stripes minus one, and decreasing the claim vector reference count by one for all remaining identical layout stripes except the single stripe.

19. The method of claim 14, where more than one virtual stripe can be stored in a single layout stripe by determining whether stripe data is compressible by more than 50%, writing a descriptor for the compressed data to be kept with the stripe; and setting a bit in the claim vector indicating that the layout stripe is compressed.

20. The method of claim 19, where data integrity information is stored as part of the descriptor.

21. The method of claim 19, where the redundancy scheme supports partially written chunks.

22. The method of claim 1, where available layout capacity can be increased by adding physical storage devices.

23. A non-transitory computer readable storage medium having embodied thereon a program, the program being executable by a processor to perform a method for constructing virtual storage volumes, the method comprising:
dividing each of a plurality of physical storage devices into a plurality of extents;
dividing each extent into a plurality of chunks;
assembling a plurality of sheets from the extents;
assembling a plurality of stripes from the chunks;
linearly concatenating the sheets into layouts using a linear vector called sheet map; and
allocating one or more stripes to a virtual volume.

24. A system for constructing virtual storage volumes, comprising:
memory;
one or more processors;
an application stored in memory and executable by the one or more processors to divide each of a plurality of physical storage devices into a plurality of extents, divide each extent into a plurality of chunks, assemble a plurality of sheets from the extents, assemble a plurality of stripes from the chunks, linearly concatenate the sheets into layouts using a linear vector called sheet map, and allocate one or more stripes to a virtual volume.

24. The system of claim 23, further comprising a plurality of storage devices containing the plurality of chunks.
